(19) United States
(12) Patent Application Publication
(10) Pub. No.: US 2024/0126381 A1
(43) Pub. Date: Apr. 18, 2024

(54) TRACKING A HANDHELD DEVICE

(71) Applicant: Meta Platforms Technologies, LLC, Menlo Park, CA (US)

(72) Inventors: Hemanth Korrapati, Maple Valley, WA (US); Kevin Joseph Sheridan, Redwood City, CA (US); Zachary Jeremy Taylor, Olten (CH); Andrew Melim, Seattle, WA (US); Sheng Shen, Shoreline, WA (US)

(21) Appl. No.: 18/486,980

(22) Filed: Oct. 13, 2023

Related U.S. Application Data
(60) Provisional application No. 63/416,262, filed on Oct. 14, 2022.

(51) Int. Cl. G06F 3/0346; G06F 3/01; G06F 3/03; G06T 7/11; G06T 7/70

(52) U.S. Cl. CPC G06F 3/0346; G06F 3/011; G06F 3/0304; G06T 7/11; G06T 7/70; G06T 2207/20132

(57) ABSTRACT

A computer-implemented method, comprising accessing an image comprising a handheld device, wherein the image is captured by one or more cameras associated with the computing device, generating a cropped image that comprises a hand of a user or the handheld device from the image by processing the image, generating a vision-based six degrees of freedom (6DoF) pose estimation for the handheld device by processing the cropped image, metadata associated with the image, and first sensor data from one or more sensors associated with the handheld device, generating a map-based 6DoF pose estimation using the handheld device, and generating a final 6DoF pose estimation for the handheld device based on the vision-based 6DoF pose estimation and the map-based 6DoF pose estimation generated using the handheld device.

### CROSS REFERENCE TO RELATED APPLICATION

This present application claims the benefit of priority under 35 U.S.C. § 119(e) to U.S. Provisional Application No. 63/416,262, filed Oct. 14, 2022, the disclosure of which is hereby incorporated by reference in its entirety for all purposes.

### TECHNICAL FIELD

This disclosure generally relates to artificial reality systems, and in particular, related to tracking a handheld device.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY

In a first embodiment, a computer-implemented method includes accessing an image comprising a handheld device, wherein the image is captured by one or more cameras associated with a headset, generating a cropped image that comprises a hand of a user or the handheld device from the image by processing the image, generating a vision-based six degrees of freedom (6DoF) pose estimation for the handheld device by processing the cropped image, metadata associated with the image, and first sensor data from one or more sensors associated with the handheld device, generating a map-based 6DoF pose estimation using the handheld device, and generating a final 6DoF pose estimation for the handheld device based on the vision-based 6DoF pose estimation and the map-based 6DoF pose estimation generated using the handheld device.

In a second embodiment, a system includes a processor, and a memory including computer readable program instructions, which when executed on the processor, program the processor to access an image comprising a handheld device, wherein the image is captured by one or more cameras associated with a headset, generate a cropped image that comprises a hand of a user or the handheld device from the image, generate a vision-based six degrees of freedom (6DoF) pose estimation for the handheld device by processing the cropped image, metadata associated with the image, and first sensor data from one or more sensors associated with the handheld device, generate a map-based 6DoF pose estimation using the handheld device, and generate a final 6DoF pose estimation for the handheld device based on the vision-based 6DoF pose estimation and the map-based 6DoF pose estimation generated using the handheld device.

In a third embodiment, a non-transient computer readable storage medium including computer readable instructions embodied therein, which when executed by one or more processors cause the processor to execute a computer-implemented method. The method includes accessing an image comprising a handheld device, wherein the image is captured by one or more cameras associated with a headset, generating a cropped image that comprises a hand of a user or the handheld device from the image by processing the image, generating a vision-based six degrees of freedom (6DoF) pose estimation for the handheld device by processing the cropped image, metadata associated with the image, and first sensor data from one or more sensors associated with the handheld device, generating a map-based 6DoF pose estimation using the handheld device, generating a final 6DoF pose estimation for the handheld device based on the vision-based 6DoF pose estimation and the map-based 6DoF pose estimation generated using the handheld device, and providing the final 6DoF pose estimation to the handheld device.

In yet other embodiments, a computer system includes a first means for storing instructions and a second means for executing the instructions to cause the computer system to perform a method. The method includes accessing an image comprising a handheld device, wherein the image is captured by one or more cameras associated with a headset, generating a cropped image that comprises a hand of a user or the handheld device from the image by processing the image, generating a vision-based six degrees of freedom (6DoF) pose estimation for the handheld device by processing the cropped image, metadata associated with the image, and first sensor data from one or more sensors associated with the handheld device, generating a map-based 6DoF pose estimation using the handheld device, generating a final 6DoF pose estimation for the handheld device based on the vision-based 6DoF pose estimation and the map-based 6DoF pose estimation generated using the handheld device, and providing the final 6DoF pose estimation to the handheld device.

These and other embodiments will become clear to one of ordinary skill in the art, in light of the following.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1A illustrates an example artificial reality system.

FIG. 1B illustrates an example augmented reality system.

FIG. 2 illustrates an example logical architecture of an artificial reality system for tracking a handheld device.

FIG. 3 illustrates an example logical structure of a handheld device tracking component.

FIG. 4 illustrates an example method for tracking a handheld device's 6DoF pose using an image and sensor data.

FIG. 5 illustrates an example computer system.

### DETAILED DESCRIPTION

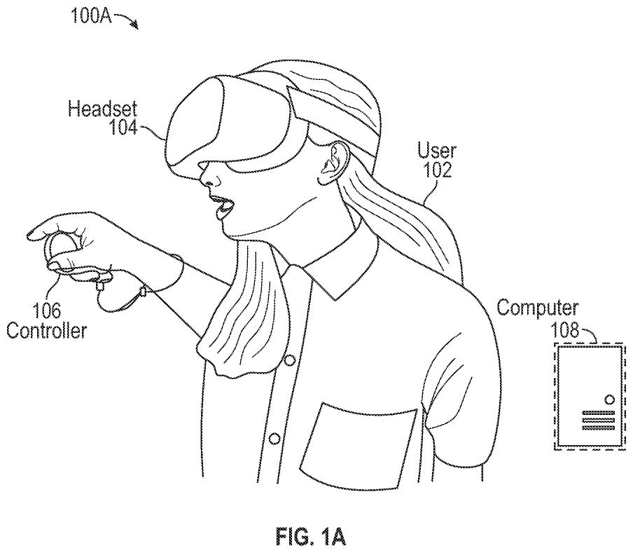

FIG. 1A illustrates an example artificial reality system 100A. In some embodiments, the artificial reality system 100A may comprise a headset 104, a controller 106, and a computing device 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may include a microphone to capture voice input from the user 102. The headset 104 may be referred as a head-mounted display (HMD). The controller 106 may comprise a trackpad and one or more buttons. The controller 106 may receive inputs from the user 102 and relay the inputs to the computing device 108. The controller 106 may also provide haptic feedback to the user 102. The computing device 108 may be connected to the headset 104 and the controller 106 through cables or wireless connections. The computing device 108 may control the headset 104 and the controller 106 to provide the artificial reality content to and receive inputs from the user 102. The computing device 108 may be a standalone host computing device, an on-board computing device integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing device 108. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The HMD 110 may include a microphone to capture voice input from the user. The augmented reality system 100B may further include a controller comprising a trackpad and one or more buttons. The controller may receive inputs from users and relay the inputs to the computing device 108. The controller may also provide haptic feedback to users. The computing device 108 may be connected to the HMD 110 and the controller through cables or wireless connections. The computing device 108 may control the HMD 110 and the controller to provide the augmented reality content to and receive inputs from users. The computing device 108 may be a standalone host computer device, an on-board computer device integrated with the HMD 110, a mobile device, or any other hardware platform capable of providing artificial reality content to and receiving inputs from users.

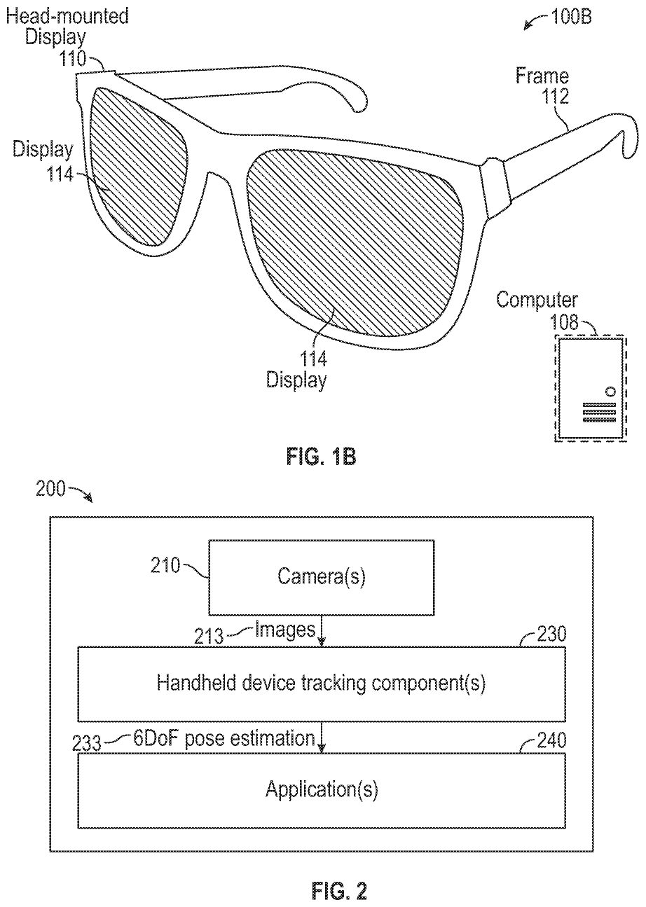

FIG. 2 illustrates an example logical architecture of an artificial reality system for tracking a handheld device. One or more handheld device tracking components 230 in an artificial reality system 200 may receive images 213 from one or more cameras 210 associated with the artificial reality system 200. The one or more handheld device tracking components 230 generates 6DoF pose estimation 233 for each of the one or more handheld devices 220 based on the received images 213. The generated 6DoF pose estimation may be a pose estimation relative to a particular point in a three-dimensional space. In some embodiments, the particular point may be a given point on a headset associated with the artificial reality system 200. In some embodiments, the given point may be a location of a camera that takes the images 213. In some embodiments, the given point may be any suitable point in the three-dimensional space. The generated 6DoF pose estimation 233 may be provided to one or more applications 240 running on the artificial reality system 200 as user input. The one or more applications 240 may interpret user's intention based on the received 6DoF pose estimation of the one or more handheld devices 220. Although this disclosure describes a particular logical architecture of an artificial reality system, this disclosure contemplates any suitable logical architecture of an artificial reality system.

In some embodiments, a computing device 108 (FIG. 1A) may access an image 213 comprising a hand of a user and/or a handheld device. In some embodiments, the handheld device may be a controller 106 (FIG. 1A) for an artificial reality system 100A. The image may be captured by one or more cameras associated with the computing device 108. In some embodiments, the one or more cameras may be attached to a headset 104. Although this disclosure describes a computing device associated with an artificial reality system 100A, this disclosure contemplates a computing device associated with any suitable system associated with one or more handheld devices.

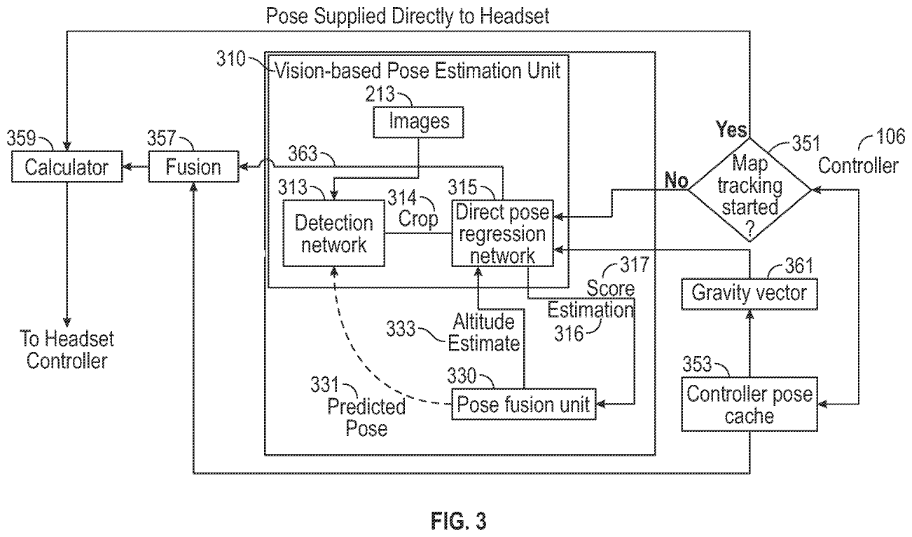

FIG. 3 illustrates example logical operations performed by a handheld device tracking component 230 of FIG. 2. In an embodiment, the example logical operations are implemented as logic blocks that are executed by a processor (e.g., processor 502). As illustrated in FIG. 3, the handheld device tracking component 230 may comprise a vision-based pose estimation unit 310 and a temporal pose fusion unit 330. A first machine-learning model 313 may receive images 213 at a pre-determined interval from one or more cameras 210. The first machine-learning model 313 may be referred to as a detection network. The first machine-learning model 313 may be or include a neural network. In some embodiments, the one or more cameras 210 may take pictures of a hand of a user or a handheld device at a pre-determined interval and provide the images 213 to the first machine-learning model 313. For example, the one or more cameras 210 may provide images to the first machine-learning model 30 times per second. In some embodiments, the one or more cameras 210 may be attached to the headset 104. In some embodiments, the handheld device may be the controller 106. Although this disclosure describes accessing an image of a hand of a user or a handheld device in a particular manner, this disclosure contemplates accessing an image of a hand of a user or a handheld device in any suitable manner.

In some embodiments, the computing device 108 may generate a cropped image that comprises a hand of a user and/or the handheld device from the image 213 by processing the image 213 using a first machine-learning model 313. As illustrated in FIG. 3, the first machine-learning model 313 may process the received image 213 along with additional information to generate a cropped image 314. The cropped image 314 may comprise a hand of a user holding the handheld device and/or a handheld device. The cropped image 314 may be provided to a second machine-learning model 315. The second machine-learning model 315 may be referred to as a direct pose regression network. The second machine-learning model 315 may be or include a neural network. The first machine-learning model 313 and the second machine-learning model 315 may form the AI network. Although this disclosure describes generating a cropped image out of an input image in a particular manner, this disclosure contemplates generating a cropped image out of an input image in any suitable manner.

In some embodiments, the computing device 108 may generate a vision-based 6DoF pose estimation for the handheld device by processing the cropped image 314, metadata associated with the image, and first sensor data from one or more sensors associated with the handheld device using a second machine-learning model. The second machine-learning model may also generate a vision-based-estimation confidence score corresponding to the generated vision-based 6DoF pose estimation. As illustrated in FIG. 3, the second machine-learning model 315 of the vision-based pose estimation unit 310 may receive a cropped image 314 from the first machine-learning model 313. The second machine-learning model 315 may also access metadata associated with the image 213 and first sensor data from the one or more IMU sensors 221 (FIG. 2) associated with the handheld device 220.

In some embodiments, the metadata associated with the image 213 may comprise intrinsic and extrinsic parameters associated with a camera that takes the image 213 and canonical extrinsic and intrinsic parameters associated with an imaginary camera with a field-of-view that captures only the cropped image 314. Intrinsic parameters of a camera may be internal and fixed parameters to the camera. Intrinsic parameters may allow a mapping between camera coordinates and pixel coordinates in the image. Extrinsic parameters of a camera may be external parameters that may change with respect to the world frame. Extrinsic parameters may define a location and orientation of the camera with respect to the world. In some embodiments, the first sensor data may comprise a gravity vector estimate generated from a gyroscope. The metadata and the first sensor data may be input to the second machine-learning model 315. The second machine-learning model 315 may generate a vision-based 6DoF pose estimation 316 and a vision-based-estimation confidence score 317 corresponding to the generated vision-based 6DoF pose estimation by processing the cropped image 314. In some embodiments, the second machine-learning model 315 may also process the metadata and the first sensor data to generate the vision-based 6DoF pose estimation 316 and the vision-based-estimation confidence score 317. Although this disclosure describes generating a vision-based 6DoF pose estimation in a particular manner, this disclosure contemplates generating a vision-based 6DoF pose estimation in any suitable manner.

In some embodiments, the second machine-learning model 315 may comprise a ResNet backbone, a feature transform layer, and a pose regression layer. The feature transform layer may generate a feature map based on the cropped image 314. The pose regression layer may generate a number of three-dimensional keypoints of the handheld device and the vision-based 6DoF pose estimation 316. The pose regression layer may also generate a vision-based-estimation confidence score 317 corresponding to the vision-based 6DoF pose estimation 316. Although this disclosure describes a particular architecture for the second machine-learning model, this disclosure contemplates any suitable architecture for the second machine-learning model.

In some embodiments, the computing device 108 may generate a final 6DoF pose estimation for the handheld device based on the vision-based 6DoF pose estimation 316. The computing device 108 may generate the final 6DoF pose estimation using an Extended Kalman Filter (EKF). As illustrated in FIG. 3, the temporal pose fusion unit 330 may generate a final 6DoF pose estimation for the handheld device based on the vision-based 6DoF pose estimation 316. The temporal pose fusion unit 330 may comprise an Extended Kalman Filter (EKF). Although this disclosure describes generating a final 6DoF pose estimation of a handheld device based on a vision-based 6DoF pose estimation in a particular manner, this disclosure contemplates generating a final 6DoF pose estimation of a handheld device based on a vision-based 6DoF pose estimation in any suitable manner.

In some embodiments, a predicted pose from the EKF may be provided to the first machine-learning model as input. In some embodiments, an estimated attitude from the EKF may be provided to the second machine-learning model as input. As illustrated in FIG. 3, the temporal pose fusion unit 330 may provide a predicted pose 331 of the handheld device to the first machine-learning model 313. The first machine-learning model 313 may use the predicted pose 331 to determine a location of the handheld device in the following/successive image. However, in some other embodiments, the predicted pose 331 is omitted.

In some embodiments, the temporal pose fusion unit 330 may provide an attitude estimate 333 to the second machine-learning model 315. The second machine-learning model 315 may use the attitude estimate 333 to estimate the following vision-based 6DoF pose estimation 316. Although this disclosure describes providing additional input to the machine-learning models by the pose fusion unit in a particular manner, this disclosure contemplates providing additional input to the machine-learning models by the pose fusion unit in any suitable manner.

Thus, as discussed above, the headset 104 provides the 6D pose of the controller directly when the controller 106 comes into the headset 140 field of view (FOV). The controller 106 also includes one or more cameras, and can track itself using the one or more cameras and supply a pose. For instance, the controller 106 includes a Simultaneous Localization And Mapping (SLAM) engine that produces its own 6D pose. Currently, after the controller is picked up, the controller attempts to localize in the maps that are already stored in its memory. Additionally or alternatively, the controller generates its own maps without support from the headset and localizes into the built maps. Localizing into a map enables the controller to estimate 6D pose for rendering the controller in VR. However, when the controllers do not contain any maps (for instance, when the controllers are brand new) or if the controller was not able to successfully localize into any of the existing maps (for instance, when the controller is in a new environment), the controller 106 wait for a map to be built for the controller to localize into. Building the map includes capturing images of the environment and processing the images. This process takes as long as 5 or 10 seconds, or even 20 seconds, for example. Because of the delay during the controller 106 is still building the map, a user experiences limited controller motion. Embodiments of the disclose are directed to systems and methods for reducing the time required to localize the controllers in 6D when the controller pose is not ready. By reducing the delay, the user is provided with control of the motion of controller relatively quickly. As a result, the user experience is improved.

Referring to FIG. 3, the computing device 108 determines at 351 whether the controller 106 has built the maps. The controller 106 and the headset 104 build their own maps when the controller 106 and the headset 104 are taken in a new environment, for instance. While the controller 106 and the headset 104 individually build the respective maps, there may not be commonality between the two maps. This may be because, the cameras of the controller 106 and the cameras of the headset 104 may be directed (pointed) in different directions. For instance, the headset 104 might be viewing the walls or the ceiling of a room, while the controller 106 cameras might be pointed towards the floor or lower portions of the wall. Only when the controller 106 has built a map such that large enough portions (areas) of the map built by the controller 106 overlap with the portions of the map built by the headset 104, it can be determined that the controller 106 has obtained a desired 6D pose. When this happens (YES at 351), the computing device 108 uses the 6D pose obtained from the controller 106 for use in the headset 104. The 6D pose is used until the controller 106 enters a new environment and needs to rebuild the maps.

When the controller 106 does not provide a 6D pose (NO at 351), because the controller is in a new environment that has not been mapped previously, the computing device 108 uses the 6D poses as estimated by the headset 104 using the AI network (first machine-learning model 313 and second machine-learning model 315), as discussed above.

FIG. 3 illustrates the handheld device tracking component 230 also including a controller pose cache 353. The controller pose cache 353 is a history of past partial poses that are obtained from the controller 106. Although the maps obtained by the controller 106 and the headset 104 do not overlap initially, the controller 106 may still possess some local pose (in the world frame) based on the starting position of the controller 106. The local pose is in a different frame relative to the frame of the pose obtained by the headset 104. This pose from the controller 106 cannot be linked with the pose from the headset due to the lack of relationship between the pose from the headset 104 and the pose from the controller 106 since the corresponding maps from the headset 104 and from controller 106 do not overlap. When the maps from the headset 104 and from controller 106 overlap, the local pose obtained by the controller 106 can be linked to the pose obtained by the headset 104, and thereby the pose of the controller 106 with respect to the headset 104 is obtained. The obtained controller pose along with the controller pose cache 353 output is directly supplied to the fusion module 357. Inside the fusion module 357 the current and previously estimated controller poses, the associated confidences, and the contents of the controller pose cache 353 are all fused using an Extended Kalman Filter (EKF) to obtain a temporally fused estimate of the controller 106 pose relative to the headset 104 frame, expressed in the headset 104 frame.

The 6D pose obtained from the controller 106 is provided to the fusion module 357 via the controller pose cache 353. The 6D pose, indicated at 363, which includes the vision-based 6DoF pose estimation 316 and a vision-based-estimation confidence score 317, as estimated by the headset 104 is also provided to the fusion module 357. The output of the fusion module 357 is provided to a calculator 359. When the controller 106 does not provide a 6D pose from map tracking (NO at 351), the calculator 359 outputs the output of the fusion module 357 as the final 6DoF pose output.

When the controller 106 provides a 6D pose from map tracking (YES at 351), the calculator compares the provided pose output from the controller 106 with the pose output of the fusion module 357. If a difference (e.g., absolute value) between the provided pose output from the controller 106 and the pose output of the fusion module 357 is less than or equal to 5 cm (or a predetermined value), the calculator 359 outputs the direct pose output from map tracking, i.e., the pose output from the controller 106. If a difference (e.g., absolute value) between the provided pose output from the controller 106 and the pose output of the fusion module 357 is more than 5 cm (or the predetermined value), the calculator 359 outputs the pose obtained from the fusion module 357.

The controller pose cache 353 including the controller's relative pose in its local frame can also be used to compute the gravity vector 361. The gravity vector 361 is the vector in the Z-direction in the 6D pose from the controller 106.

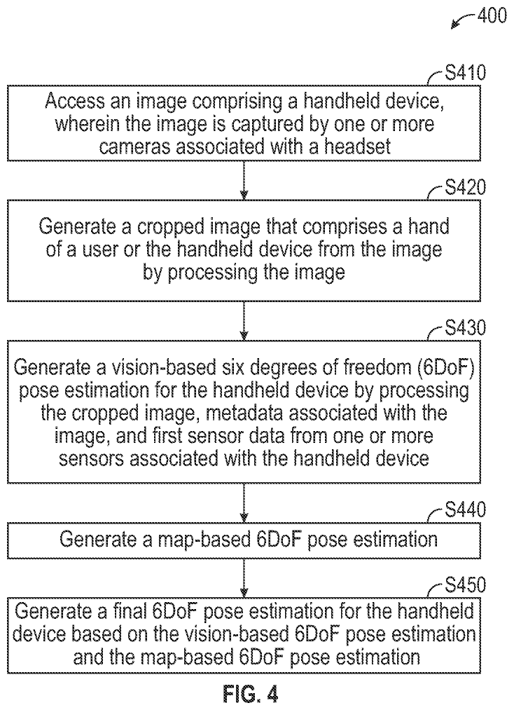

FIG. 4 illustrates an example method 400 for tracking a handheld device's 6DoF pose using an image and sensor data. It is understood that additional operations can be provided before, during, and after processes discussed in FIG. 6, and some of the operations described below can be replaced or eliminated, for additional embodiments of the method. The order of the operations/processes may be interchangeable and at least some of the operations/processes may be performed in a different sequence. At least two or more operations/processes may be performed overlapping in time, or almost simultaneously.

The method includes operation 5410 of accessing an image comprising a handheld device, wherein the image is captured by one or more cameras associated with a headset. The image may be captured by one or more cameras associated with the computing device 108. At operation 5420, a cropped image is generated that comprises a hand of a user or the handheld device from the image by processing the image. At operation 5430, a vision-based six degrees of freedom (6DoF) pose estimation for the handheld device is generated by processing the cropped image, metadata associated with the image, and first sensor data from one or more sensors associated with the handheld device. At operation 5440, a map-based 6DoF pose estimation using the handheld device is generated. At operation 5450, a final 6DoF pose estimation for the handheld device is generated based on the vision-based 6DoF pose estimation and the map-based 6DoF pose estimation generated using the handheld device.

### Systems and Methods

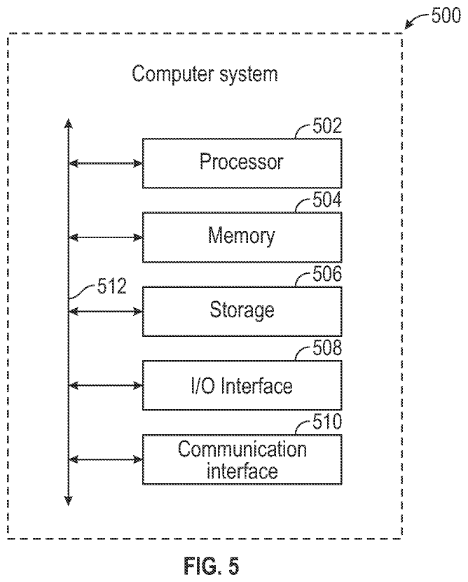

FIG. 5 illustrates an example computer system 500. In some embodiments, one or more computer systems 500 perform one or more steps of one or more operation described or illustrated herein. In some embodiments, one or more computer systems 500 provide functionality described or illustrated herein. In some embodiments, software running on one or more computer systems 500 performs one or more steps of one or more operations described or illustrated herein or provides functionality described or illustrated herein. Some embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In some embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In some embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In some embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual—address translation for processor 502. In some embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In some embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In some embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In some embodiments, one or more memory management units (MMUs) reside between processor 502 and memory 504 and facilitate accesses to memory 504 requested by processor 502. In some embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In some embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In some embodiments, storage 506 is non-volatile, solid-state memory. In some embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In some embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In some embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In some embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein may be considered to be at least equivalent.

As used herein, the phrase “at least one of” preceding a series of items, with the term “or” to separate any of the items, modifies the list as a whole, rather than each item of the list. The phrase “at least one of” does not require selection of at least one item; rather, the phrase allows a meaning that includes at least one of any one of the items, and/or at least one of any combination of the items, and/or at least one of each of the items. By way of example, the phrase “at least one of A, B, or C” may refer to: only A, only B, or only C; or any combination of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain.

It is understood that some or all steps, operations, or processes may be performed automatically, without the intervention of a user. Method clauses may be provided to present elements of the various steps, operations, or processes in a sample order, and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the included clauses. Moreover, nothing disclosed herein is intended to be dedicated to the public regardless of whether such disclosure is explicitly recited in the clauses. No clause element is to be construed under the provisions of 35 U.S.C. § 112 (f) unless the element is expressly recited using the phrase “means for” or, in the case of a method, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a clause.

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the clauses. In addition, in the Detailed Description, it can be seen that the description provides illustrative examples and the various features are grouped together in various embodiments for the purpose of streamlining the disclosure. This method of disclosure is not to be interpreted as reflecting an intention that the included subject matter requires more features than are expressly recited in any clause. Rather, as the clauses reflect, inventive subject matter lies in less than all features of a single disclosed configuration or operation. The clauses are hereby incorporated into the Detailed Description, with each clause standing on its own to represent separately patentable subject matter.

The clauses are not intended to be limited to the aspects described herein but are to be accorded the full scope consistent with the language of the clauses and to encompass all legal equivalents. Notwithstanding, none of the clauses are intended to embrace subject matter that fails to satisfy the requirement of 35 U.S.C. § 101, 102, or 103, nor should they be interpreted in such a way.

What is claimed is:

1. A computer-implemented method, comprising:
accessing an image comprising a handheld device, wherein the image is captured by one or more cameras associated with a headset;
generating a cropped image that comprises a hand of a user or the handheld device from the image by processing the image;
generating a vision-based six degrees of freedom (6DoF) pose estimation for the handheld device by processing the cropped image, metadata associated with the image, and first sensor data from one or more sensors associated with the handheld device;
generating a map-based 6DoF pose estimation using the handheld device; and
generating a final 6DoF pose estimation for the handheld device based on the vision-based 6DoF pose estimation and the map-based 6DoF pose estimation generated using the handheld device.

2. The method of claim 1, wherein the final 6DoF pose estimation for the handheld device is generated in an absence of a desired amount of overlap between the vision-based 6DoF pose estimation and the map-based pose estimation generated using the handheld device.

3. The method of claim 1, wherein the final 6DoF pose estimation for the handheld device is generated in a presence of a desired amount of overlap between the vision-based 6DoF pose estimation and the map-based 6DoF pose estimation generated using the handheld device.

4. The method of claim 1, further comprising generating a vision-based-estimation confidence score corresponding to the generated vision-based 6DoF pose estimation.

5. The method of claim 4, wherein the cropped image is generated using a first machine-learning model, and the vision-based 6DoF pose estimation and the vision-based-estimation confidence score are generated using a second machine-learning model.

6. The method of claim 1, further comprising providing the final 6DoF pose estimation to the handheld device.

7. The method of claim 1, wherein generating the final 6DoF pose estimation includes generating the vision-based six degrees of freedom (6DoF) pose estimation as the final 6DoF pose estimation in the absence of a map-based pose provided by the handheld device.

8. The method of claim 1, wherein in a presence of a map-based pose provided by the handheld device, the method further includes:
calculating a difference between the map-based pose provided by the handheld device and the vision-based 6DoF pose estimation,
generating the final 6DoF pose estimation as the map-based pose provided by the handheld device when the difference is less than or equal to a predetermined value, and
generating the final 6DoF pose estimation as the vision-based 6DoF pose estimation when the difference is greater than a predetermined value.

9. A system, comprising:
a processor; and
a memory including computer readable program instructions, which when executed on the processor, program the processor to:
access an image comprising a handheld device, wherein the image is captured by one or more cameras associated with a headset;
generate a cropped image that comprises a hand of a user or the handheld device from the image;
generate a vision-based six degrees of freedom (6DoF) pose estimation for the handheld device by processing the cropped image, metadata associated with the image, and first sensor data from one or more sensors associated with the handheld device;
generate a map-based 6DoF pose estimation using the handheld device; and
generate a final 6DoF pose estimation for the handheld device based on the vision-based 6DoF pose estimation and the map-based 6DoF pose estimation generated using the handheld device.

10. The system of claim 9, wherein the processor is further programmed to generate the final 6DoF pose estimation for the handheld device in an absence of a desired amount of overlap between the vision-based 6DoF pose estimation and the map-based pose estimation generated using the handheld device.

11. The system of claim 9, wherein the processor is further programmed to generate the final 6DoF pose estimation for the handheld device in a presence of a desired amount of overlap between the vision-based 6DoF pose estimation and the map-based 6DoF pose estimation generated using the handheld device.

12. The system of claim 9, wherein the processor is further programmed to generate a vision-based-estimation confidence score corresponding to the generated vision-based 6DoF pose estimation.

13. The system of claim 9, wherein the processor is further programmed to generate the vision-based six degrees of freedom (6DoF) pose estimation as the final 6DoF pose estimation in the absence of a map-based pose provided by the handheld device.

14. The system of claim 9, wherein in a presence of a map-based pose provided by the handheld device, the processor is further programmed to:
calculate a difference between the map-based pose provided by the handheld device and the vision-based 6DoF pose estimation,
generate the final 6DoF pose estimation as the map-based pose provided by the handheld device when the difference is less than or equal to a predetermined value, and
generate the final 6DoF pose estimation as the vision-based 6DoF pose estimation when the difference is greater than a predetermined value.

15. The system of claim 9, wherein the processor is further programmed to provide the final 6DoF pose estimation to the handheld device.

16. A non-transient computer readable storage medium including computer readable instructions embodied therein, which when executed by one or more processors cause the processor to execute a computer-implemented method, the method comprising:
accessing an image comprising a handheld device, wherein the image is captured by one or more cameras associated with a headset;
generating a cropped image that comprises a hand of a user or the handheld device from the image by processing the image;
generating a vision-based six degrees of freedom (6DoF) pose estimation for the handheld device by processing the cropped image, metadata associated with the image, and first sensor data from one or more sensors associated with the handheld device;
generating a map-based 6DoF pose estimation using the handheld device;
generating a final 6DoF pose estimation for the handheld device based on the vision-based 6DoF pose estimation and the map-based 6DoF pose estimation generated using the handheld device; and
providing the final 6DoF pose estimation to the handheld device.

17. The non-transient computer readable storage medium of claim 16, wherein the final 6DoF pose estimation for the handheld device is generated in an absence of a desired amount of overlap between the vision-based 6DoF pose estimation and the map-based pose estimation generated using the handheld device.

18. The non-transient computer readable storage medium of claim 16, wherein the final 6DoF pose estimation for the handheld device is generated in a presence of a desired amount of overlap between the vision-based 6DoF pose estimation and the map-based 6DoF pose estimation generated using the handheld device.

19. The non-transient computer readable storage medium of claim 16, wherein generating the final 6DoF pose estimation includes generating the vision-based six degrees of freedom (6DoF) pose estimation as the final 6DoF pose estimation in the absence of a map-based pose provided by the handheld device.

20. The non-transient computer readable storage medium of claim 16, wherein in a presence of a map-based pose provided by the handheld device, the method further includes:
calculating a difference between the map-based pose provided by the handheld device and the vision-based 6DoF pose estimation,
generating the final 6DoF pose estimation as the map-based pose provided by the handheld device when the difference is less than or equal to a predetermined value, and
generating the final 6DoF pose estimation as the vision-based 6DoF pose estimation when the difference is greater than a predetermined value.
